(19) United States
(12) Patent Application Publication
(10) Pub. No.: US 2006/0218474 A1
(43) Pub. Date: Sep. 28, 2006

(54) Self-service acquisition of digital content

(76) Inventors: Gerald W. Pfleging, Batavia, IL (US); George P. Wilkin, Bolingbrook, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/087,444

(22) Filed: Mar. 23, 2005

(51) Int. Cl. G06F 17/00

(52) U.S. Cl. 715/500

(57) ABSTRACT

A self-service kiosk in one example provides a user with selectable digital content. A computer controls the operation of the kiosk. A user transaction interface module, connected to the computer, communicates information to and from the about the digital content desired by the user and payment for providing file download services. A user download interface module selectively makes accessible a physical connection port by which the download file is transmitted to a removable storage media supplied by the user that is coupled to the port.

### BACKGROUND

The present invention is directed to providing users with digital content in a self-service environment and is more specifically directed to transferring a user selected digital content to storage media supplied by the user. The invention is especially, but not exclusively, suited for dispensing digital content such as movies or music to a user from a retail, self-service kiosk such as at an airport.

Digital content such as movies and music is becoming increasingly popular. Movies and music may be bought or rented on DVDs and CDs, respectively. Such digital media can be accessed by a user's personal computer or with portable audio and/or video player devices. This has generally proved to be popular and convenient where the desired digital content is available to the user on pre-recorded media.

Large digital files can be downloaded utilizing a personal computer with a high-speed Internet connection within a reasonable time. Such files can then be stored on CDs or DVDs or transferred into memory utilized by a portable audio and/or video player device so that a user can easily take and enjoy the digital content while traveling or at a remote location. Alternatively, the files can be stored on the hard disk of the user's personal computer for playback in a later time if the personal computer will be taken along. Regardless of whether a portable player device or a PC is utilized for playback, the user must have previously identified, downloaded and stored the desired digital content before leaving the connected computing environment, typically the user's home.

However, there are situations in which a user may desire to have access to specific digital content that is not conveniently available to the user on DVD or CD, and where the digital file is unavailable or inconvenient to be downloaded. For example, a user during a trip is at a point of departure, e.g. an airport, and then decides that a specific digital content, e.g. a particular movie, would be enjoyable to watch during the flight. The user is carrying a laptop computer or a portable playing device but the storage media utilized by the carried electronic device does not contain the desired digital content. There is no retail store that rents DVDs in the airport. Even if such a store was available, returning a rented DVD to that store or even to another store in the same rental chain could be inconvenient. The user is either carrying a portable playing device that does not support downloading of digital files over the Internet or is carrying an electronic device, e.g. a laptop computer, that supports downloading of digital files over the Internet, but an Internet connection of sufficient speed or with appropriate access is not available to the user at the airport. Even with appropriate Internet access, the desired movie may not be available to the user as a download. Therefore, the user will not be able to acquire the desired digital content in order to enjoy it during the flight. There exists a need to provide alternate access to digital content for users.

### SUMMARY

It is an object of the present invention to satisfy this need.

The invention in one implementation encompasses an apparatus. The apparatus comprises a self-service kiosk that provides a user with selectable digital content. A computer controls the operation of the kiosk. A user transaction interface module, connected to the computer, communicates information to and from the user about the digital content desired by the user and payment for providing file download services. A user download interface module selectively makes accessible a physical connection port by which the download file is transmitted to a removable storage media supplied by the user that is coupled to the port.

Another implementation of the invention encompasses a method for downloading a file containing digital content selected by a user from a self-service kiosk. Manual input is received from the user at a user transaction interface of the kiosk where the manual input identifies the digital content desired by the user. A payment transaction is automatically completed with the assistance of a computer contained in the kiosk where the user provides account and authentication information permitting a fee associated with the downloading services to be paid. A physical connection port is changed from a first position that is inaccessible for engagement by storage media supplied by the user to a second position that is accessible for engagement by storage media supplied by the user. Following connection of the storage media supplied by the user with the connection port, downloading the file containing the digital content to the storage media is completed.

### DESCRIPTION OF THE DRAWINGS

Features of exemplary implementations of the invention will become apparent from the description, the claims, and the accompanying drawings in which:

FIG. 1 is a block diagram illustrating an exemplary kiosk in accordance with an embodiment of the present invention.

FIGS. 2, 3 and 4 are block diagrams of embodiments of user download interfaces as shown in FIG. 1.

FIG. 5 is a flow diagram of an exemplary method for providing digital content to a user in accordance with the present invention.

### DETAILED DESCRIPTION

The following terms as used herein have the stated meaning. A “kiosk” means a small structure or segregated area of a larger structure for supplying the public with a service. “Self-service” means providing a customer with the ability to acquire and pay for a service without the assistance of a clerk. “User access device” means an electronic device capable of accepting and storing a digital file.

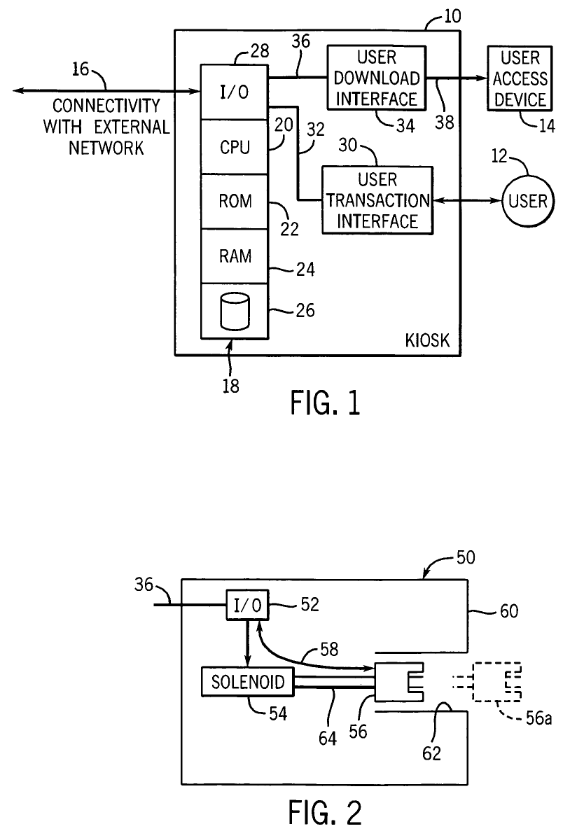

FIG. 1 shows an exemplary embodiment in which a kiosk 10 is in a location serving the public such as in an airport passenger terminal. A user 12 is traveling with an access device 14 which may comprise in a laptop computer, video and/or audio playback device. The kiosk 10 provides self-service access to digital content for user 12. Although a communication path 16 is shown as providing connectivity between the kiosk 10 and an external network, it will be understood that such a communication path may not be required for all applications.

The kiosk 10 includes a computer 18 having a central processing unit (CPU) 20 that is supported by read-only memory (ROM) 22, random access memory (RAM) 24 and nonvolatile data storage 26 such as a hard drive. An input/output (I/O) module 28 provides computer 18 with incoming and outgoing communications capability. It will be apparent to those skilled in the art that ROM 22 in combination with data storage 26 store program control instructions, operating data and the storage of files utilized during the operation of the computer which is under the control of CPU 20.

A user transaction interface 30 is coupled to the computer 18 by communication path 32. In this illustrative embodiment the user transaction interface 30 facilitates communications with user 12. It may include a touch-screen monitor, keyboard, predefined instructional buttons, credit card reader and/or wireless communications capability such as Bluetooth to facilitate communications between the kiosk 10 and user 12. In the illustrative example, the user transaction interface 30 facilitates the receipt of manually entered instructions from user 12 as to the specific digital content desired and a credit card payment transaction for services provided including the download of the specified digital content.

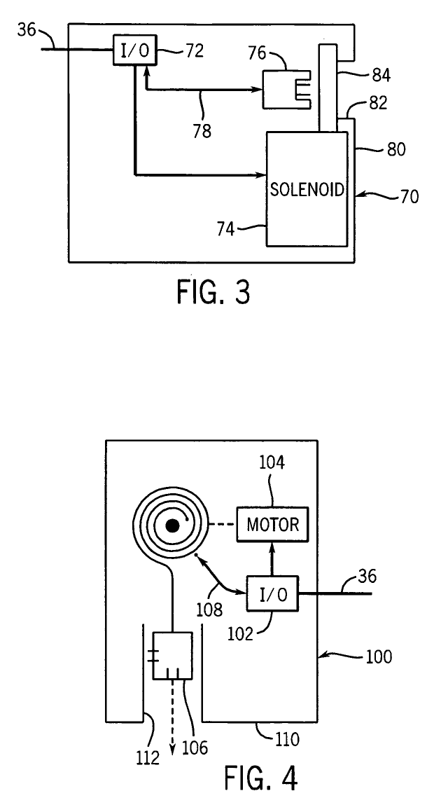

A user download interface 34 is connected to the computer 18 by communication path 36 and is connectable to the user access device 14 and/or storage media utilized by the access device by a communication path 38. The user download interface 34 provides a controlled physical interconnection that can be made accessible to the user access device 14 under the control of computer 18. The purpose of the user download interface 34 is to provide a physical connection through which digital content selected by the user can be downloaded to the user's access device and/or storage media utilized by the user access device. The user download interface 34 will be explained in further detail below with regard to exemplary embodiments shown in FIGS. 2-4.

FIG. 2 illustrates an embodiment of a user download interface 50. It contains an input/output (I/O) interface 52 coupled to communication path 36, solenoid 54 and a communication port 56, e.g. USB connector, by an extendable cable 58. A housing 60 includes a recess defined by walls 62 dimensioned to allow the USB connector 56 to move from an interior position that is inaccessible for engagement with the user's access device 14 to an extended, accessible position 56a. Solenoid 54 includes an extendible element or rod 64 connected to USB connector 56. When the solenoid is in a non-driven state, the rod 64 and connector 56 are in the position as shown; when the solenoid is in the driven state, the rod 64 and connector 56 are extended so that the connector occupies the position at 56a. Signals generated by computer 18 are transmitted by communication path 36 to the I/O interface 52 to control the solenoid 54. After the user 12 has successfully identified available digital content to be acquired and satisfied payment requirements, computer 18 will cause the USB connector 56 to move to position 56a to facilitate the user coupling the user access device 14 and/or storage media for the device to the connector in preparation for receiving a download of the desired digital content. The computer 18 will cause the transmission of the desired digital content through communication path 36, I/O interface 52, cable 58 and connector 56 to the user access device. Following a successful download of the digital content, the user will be instructed by the user transaction interface 30 to remove the user access device 14 from connector 56. Following this disconnection, the connector 56 will be withdrawn to the inaccessible position within housing 60. This will conclude the interaction by kiosk 10 with the user 12. It will be apparent to those skilled in the art that various types of physical ports (connectors) and communication formats can be utilized to facilitate communications between the computer 18 and the user access device 14.

FIG. 3 illustrates another embodiment of a user download interface 70. It contains an input/output (I/O) interface 72 coupled to communication path 36, solenoid 74 and USB connector 76 by a cable 78. A housing 80 includes a recess defined by walls 82 dimensioned to allow access to the USB connector 76. Solenoid 74 includes a rod 84 that extends in front of and can selectively block access to USB connector 76. When the solenoid is in a non-driven state, the rod 84 is in the position as shown; when the solenoid is in the driven state, the rod 84 retracts to permit access to connector 76 through the opening between walls 82 of the housing 80. Signals generated by computer 18 are transmitted by communication path 36 to the I/O interface 72 to control the solenoid 74. After the user 12 has successfully identified available digital content to be acquired and satisfied payment requirements, computer 18 will cause the solenoid 74 to retract the rod 84 to facilitate the user connecting the user access device 14 and/or storage media for the device to the connector in preparation for receiving a download of the desired digital content. The computer 18 will cause the transmission of the desired digital content through communication path 36, I/O interface 72, cable 78 and connector 76 to the user access device. Following a successful download of the digital content, the user will be instructed by the user transaction interface 30 to remove the user access device 14 from connector 76. Following this disconnection, the rod 84 of the solenoid will be again extended to make the USB connector inaccessible. This will conclude the interaction by kiosk 10 with the user 12.

FIG. 4 illustrates a further embodiment of a user download interface 100. It contains an input/output (I/O) interface 102 coupled to communication path 36, motor 104 and USB connector 106 by an extendable cable 108. The cable 108 may be stored on a take-up spool driven by motor 104. A housing 110 includes a recess defined by walls 112 dimensioned to allow the USB connector 106 to be withdrawn up into an inaccessible position as shown or to drop down through the recess to become accessible to the user. Motor 104 includes a shaft that extends to the take-up spool and is controlled to cause the connector 106 to move between inaccessible and accessible positions. Signals generated by computer 18 are transmitted by communication path 36 to the I/O interface 102 to control the motor 104. After the user 12 has successfully identified available digital content to be acquired and satisfied payment requirements, computer 18 will cause the motor 104 to extend the connector 106 in the direction of the arrow to facilitate the user coupling the user access device 14 and/or storage media to the connector in preparation for receiving a download of the desired digital content. The computer 18 will cause the transmission of the desired digital content through communication path 36, I/O interface 102, cable 108 and connector 106 to the user access device. Following a successful download of the digital content, the user will be instructed by the user transaction interface 30 to remove the user access device 14 from connector 106. Following this disconnection, the motor 104 will take up the USB connector making it again inaccessible within housing 110. This will conclude the interaction by kiosk 10 with the user 12. In this embodiment it is preferred that the housing 110 be oriented so that the recess defined by walls 112 faces generally downward so that gravity can assist connector 106 with exiting through the recess. The connector 106 can be any of a plurality of types of physical connectors to enhance the variety of connections that can be made. For example, the connector can establish communications utilizing USB, serial port, parallel port, fire wire and other types of standardized physical interconnections and corresponding communication protocols.

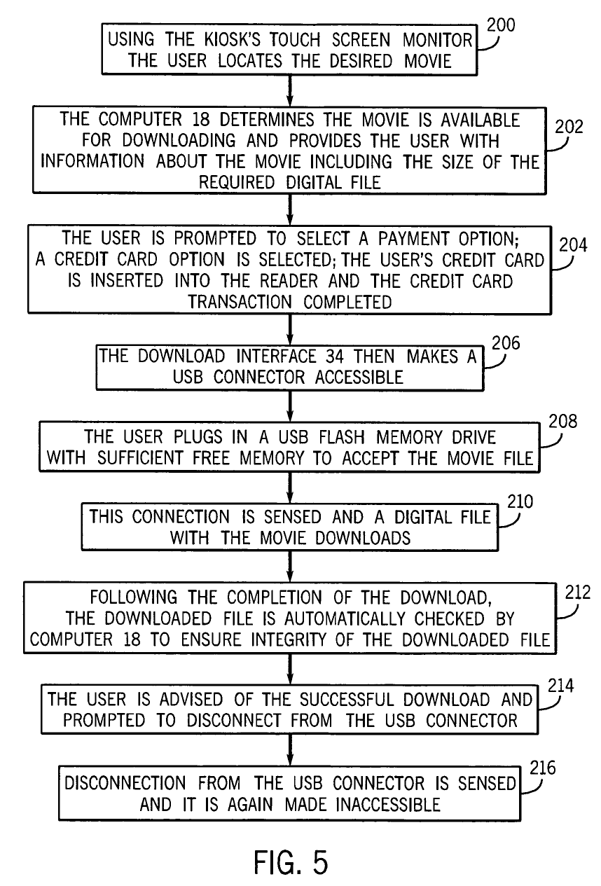

FIG. 5 is a flow diagram of an exemplary method in accordance with the present invention. In this example, a user is traveling and has arrived at an airport terminal in preparation for a departure to a destination city. The user is carrying a laptop computer for both business and pleasure use during the flight. While in the terminal, the user overhears a conversation in which a particular movie is discussed as being a really enjoyable movie. The user, who was already interested in the movie but had not seen it, decides that watching this movie during the upcoming flight would be enjoyable. A store that rents DVDs is not available in the terminal and even if such a store was available, the user will be traveling to a destination that would make returning a rented DVD inconvenient. While walking through the terminal the user sees kiosk 10 and the steps described in the following exemplary method enable the user to obtain the desired movie.

In step 200 the user 12 uses a touch screen monitor of the user transaction interface 30 of kiosk 10 to locate the desired movie. This may include selecting a “movie” category and entering the name of the movie or scrolling through a tree structure of screens permitting the user to find the desired movie. In this example, the user locates the desired movie and identifies it such as by highlighting the corresponding entry or checking an associated box presented on the screen of the touch monitor. Alternatively, other commonly used input techniques utilizing a keyboard, mouse, pointing device, predetermined function buttons, etc. as well as wireless communications such as from the user's personal computer to the kiosk could be used to facilitate interaction between the user and the kiosk.

The computer 18 determines that the movie is available for download in step 202 in response to the specific movie being selected by the user. Information about the movie is provided to the user by the kiosk including the size of the required digital file containing the movie. This allows the user to confirm the user's selection of the particular movie and to determine that sufficient memory is available in the storage media to store the digital file. The movie file may either be located on an external network connected by communication path 16 or stored locally in disk drive 26 of computer 18. In step 204 the user is prompted to select a payment option. For example, payment for services provided by the kiosk can be by debiting an established account maintained by the operator of the kiosk, depositing currency into an automated money acceptance system, or using a conventional credit card. In this example the user elects to use a credit card. The user's credit card is inserted into a credit card reader and a conventional credit card transaction is completed by the user providing an electronic signature authorizing the corresponding charge. In this example the credit card transaction is processed by computer 18 utilizing communication path 16 to contact a credit card authorization center. The utilization of communication path 16 is not necessarily required depending upon the payment option selected.

With payment having been completed, download interface 34 makes a USB connector accessible in step 206. If a variety of different types of connectors are supported by the kiosk, the user may be presented with an option to select the particular type of connector and/or communication protocol to be utilized. In this example download interface 60 is being utilized. In accordance with this step, USB connector 56 is made accessible to the user by the connector being moved to the position indicated as 56a.

In step 208 the user plugs in a USB flash memory drive, with sufficient free memory to accept the digital movie file, into mating connector 56a. The user may have elected to use a USB flash memory drive instead of downloading the movie directly into the hard drive of the user's laptop computer because the laptop may be restricted for business use only. Alternatively, the user may merely find it convenient to store the movie in such a portable storage media in case the user later desires to watch the same movie again on another computer. It will be apparent that various types of other media exist that are capable of storing a digital file such as, for example, compact flash modules and other commonly used removable memory modules associated with digital cameras and portable audio/video players. Of course, the user could have elected to directly download the digital movie file onto the hard drive of the laptop computer by connecting the computer to connector 56a with a conventional USB cable.

In step 210 the connection with the USB flash memory drive is sensed by computer 18 and a digital file containing the movie is begun to be downloaded. Prior to beginning the download, it may be preferable to have the computer 18 read the directory of the connected media to ensure that sufficient free memory space is available to accommodate the size of the download file. The movie file being downloaded may reside in storage 26 of computer 18 or may be retrieved from a remote location by communication path 16. Alternatively, computer 18 can function as a read ahead buffer and begin downloading be movie file from communication path 16 into local data storage 26 or 24 as soon as the user identified the particular movie of interest in order to have the movie content available locally so that the file transfer can begin immediately as soon as the USB connection is established and ready.

In step 212 following the completion on the download of the movie file, the downloaded file is automatically checked by computer 18 to ensure integrity of the file contents. The granularity of the checking can be adapted to match the normal download results. Simply checking that the size of the downloaded file matches the expected file size may be sufficient where a high probability exists that the downloaded file will not contain fatal errors. Alternatively, various types of check sum encoding and verification can be utilized as well as other types of error correction coding/error verification techniques to ensure that the downloaded movie file can be played by the user. It will be apparent to those skilled in the art that some errors with regard to pixel rendition or sound production can be tolerated while an error that causes a significant disruption to the playing of the movie should not be allowed.

The user is advised of the successful download of the movie file in step 214. During the download process, the user is preferably informed as to the overall progress of the download such as by providing an estimate of the remaining time to complete the download or by a commonly used horizontal bar that indicates the degree of completion by a color that progressively fills the bar. The user will then be prompted to disconnect the storage media from the USB connector. Following the disconnection of the storage media from the USB connector in step 216, this disconnection is sensed by computer 18. Since this completes the transaction and downloading the entire movie file, the download interface 60 will then cause the USB connector 56 to return to its inaccessible position. It is desirable to normally keep the connection port 56 in an inaccessible position to minimize malicious physical and/or electrical damage.

This completes the services provided by the kiosk. The user now has a USB flash memory drive that contains the desired digital movie file. It will be appreciated that the movie file probably will have been compressed such as by using one of the known compression techniques in order to keep the file within a reasonable size. Thus, the user will have received the movie file in a compressed format thereby requiring the laptop computer and/or video playback device to be compatible with the format utilized for the compression. Since such compression techniques are or are becoming standardized, this does not present a significant difficulty. Control of the usage of the downloaded file, such as limiting the number of times the movie can be played or limiting the time frame during which the movie can be played, are issues that will be relevant to the owner of the subject matter content. However, various techniques are available that can be utilized to provide the subject matter owner with sufficient control so as to overcome concerns about losing control over the subject matter itself.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus for providing a user with selectable digital content, comprising:
a kiosk including:
a computer adapted for controlling the operation of the kiosk;
a user transaction interface module, connected to the computer, that communicates information to the user and receives information from the user including information about the digital content desired by the user and payment for providing a download file containing the desired digital content;
a user download interface module, connected to the computer, that selectively makes accessible a physical connection port by which the download file with the desired digital content is transmitted to a removable storage media supplied by the user that is coupled to the port.

2. The apparatus of claim 1 further comprising a communication path coupled to the computer that supports communications between the computer and an external network.

3. The apparatus of claim 1 wherein the user transaction interface module is adapted to accept information manually entered by the user and to visually display information to be communicated to the user.

4. The apparatus of claim 3 wherein the user transaction interface module includes the capability to read information from a credit card provided by the user.

5. The apparatus of claim 1 wherein the user download interface module includes a mechanism operating under the control of the computer that selectively makes to the connection port physically accessible and inaccessible to the storage media supplied by the user.

6. The apparatus of claim 5 wherein the mechanism comprises a solenoid.

7. The apparatus of claim 6 further comprising a housing containing the mechanism, wherein the solenoid includes a movable element that is connected to the connection port so as to cause the connection port to be withdrawn into the housing making the port inaccessible to the storage media supplied by the user in a first position and cause the connection port to be extended beyond the housing making the port accessible to the storage media supplied by the user in a second position.

8. The apparatus of claim 6 wherein the solenoid includes a movable element that operates between a first extended position and a second retracted position, the solenoid mounted relative to the connection port so that the movable element in its first extended position makes the connection port inaccessible to the storage media supplied by the user and in its second retracted position makes the connection port accessible to the storage media supplied by the user.

9. The apparatus of claim 5 further comprising a housing containing the mechanism, wherein the mechanism comprises a motor, operated under the control of the computer, that is coupled to a cable connected to the connection port and is operable to cause the connection port to be withdrawn into the housing so that the connection port is accessible to the storage media supplied by the user or extended beyond the housing where the connection port is available for connection to the storage media supplied by the user.

10. The apparatus of claim 1 wherein the kiosk is a self-service kiosk.

11. A method for downloading a file containing digital content selected by a user from a self-service kiosk comprising the steps of:
receiving manual input from the user at a user transaction interface of the kiosk where the manual input identifies the digital content desired by the user;
automatically completing a payment transaction with the assistance of a computer contained in the kiosk in which the user provides account and authentication information permitting a fee associated with the downloading services to be paid;
changing a physical connection port from a first position that is inaccessible for engagement by storage media supplied by the user to a second position that is accessible for engagement by storage media supplied by the user;
following connection of the storage media supplied by the user with the connection port, downloading the file containing the digital content to the storage media is completed.

12. The method of claim 11 further comprising the step of acquiring the digital content from a network external to the kiosk by using a communication path existing between the kiosk and the external network.

13. The method of claim 11 wherein the step of automatically completing a payment transaction includes the step of reading information from a credit card supplied by the user.

14. The method of claim 11 wherein the changing step comprises changing the physical position of the connection port relative to the housing.

15. The method of claim 11 wherein the changing step comprises causing a retractable element located adjacent the connection port to move from a first position that prevents engagement of the storage media with the connection port to a second position that allows engagement of the storage media with the connection port.

16. An apparatus for downloading a file containing digital content selected by a user from a self-service kiosk comprising:
means for receiving manual input from the user at a user transaction interface of the kiosk where the manual input identifies the digital content desired by the user;
means for automatically completing a payment transaction with the assistance of a computer contained in the kiosk in which the user provides account and authentication information permitting a fee associated with the downloading services to be paid;
means for changing a physical connection port from a first position that is inaccessible for engagement by storage media supplied by the user to a second position that is accessible for engagement by storage media supplied by the user;
means for downloading the file containing the digital content to the storage media following connection of the storage media supplied by the user with the connection port.

17. The apparatus of claim 16 further comprising means for acquiring the digital content from a network external to the kiosk by using a communication path existing between the kiosk and the external network.

18. The apparatus of claim 16 wherein the means for automatically completing a payment transaction includes means for reading information from a credit card supplied by the user.

19. The apparatus of claim 16 wherein the means for changing comprises means for changing the physical position of the connection port relative to the housing.

20. The apparatus of claim 16 wherein the means for changing comprises means for causing a retractable element located adjacent the connection port to move from a first position that prevents engagement of the storage media with the connection port to a second position that allows engagement of the storage media with the connection port.
